(19) United States
(12) Patent Application Publication
(10) Pub. No.: US 2013/0174952 A1
(43) Pub. Date: Jul. 11, 2013

(54) TYRE HAVING A TREAD COMPRISING A DEGRADABLE FILLER MATERIAL

(71) Applicants: Vincent Abad, Clermont-Ferrand (FR); Emmanuel Custodero, Clermont-Ferrand (FR)

(72) Inventors: Vincent Abad, Clermont-Ferrand (FR); Emmanuel Custodero, Clermont-Ferrand (FR)

(73) Assignees: MICHELIN RECHERCHE ET TECHNIQUE S.A., Granges-Paccot (CH); COMPAGNIE GENERALE DES ETABLISSEMENTS MICHELIN, Clermont-Ferrand (FR)

(21) Appl. No.: 13/819,899

(22) PCT Filed: Aug. 9, 2011
(86) PCT No.: PCT/EP2011/063665

§ 371 Date: Mar. 21, 2013

(30) Foreign Application Priority Data
Sep. 2, 2010 (FR) 1056959

(51) Int. Cl. B60C 1/00

(52) U.S. Cl. CPC B60C 1/0016
USPC 152/209.1; 264/171.1; 156/293; 524/41

(57) ABSTRACT

A tyre tread includes a cellulose-based filler material placed in a cavity of the tread. The filler material includes a blend of a degradable cellulose-based thermoplastic and an unsaturated thermoplastic elastomer.

### FIELD OF THE INVENTION

The present invention relates to tyres and more particularly to a tread of a tyre appropriate for exhibiting a different tread pattern when the tyre is worn down.

### State Of The Art

In a known way, the tread of a tyre, whether intended to equip a passenger vehicle or a heavy duty vehicle, is provided with a tread pattern comprising in particular tread pattern elements or elementary blocks delimited by various main grooves, which are longitudinal, transverse or even oblique, it being possible for the elementary blocks in addition to comprise various incisions or thinner strips. The grooves form channels intended to discharge water during running on wet ground and define the attack edges of the tread pattern elements.

When a tyre is new, the tread has its maximum height. This initial height can vary as a function of the type of tyre under consideration and the use for which it is intended; by way of example, “winter” tyres generally have a greater tread pattern depth than that of “summer” tyres. When the tyre wears out, the height of the elementary blocks of the tread pattern decreases and the stiffness of these elementary blocks increases. The increase in stiffness of the tread pattern elementary blocks results in a decline in some aspects of the performance of the tyre, such as the wet behaviour or grip. Furthermore, the abilities to discharge water greatly decrease when the depth of the channels of the tread patterns decreases.

It is therefore desirable to have better maintenance of the performance of a tyre with the wear of its tread.

The document U.S. Pat. No. 7,581,575 B2 provides, with the aim of maintaining the operating properties of the treads as they wear, a tyre with a tread comprising a degradable filler material placed in a cavity, in which the filler material is a cellulose-based hydrolysable material. This document indicates that, when the cavity filled with the hydrolysable filler material becomes exposed on contact with the ground by the wear of the tread of the tyre, the filler material breaks up and is discharged from the cavity, which thus strengthens the channels of the tread pattern.

The Applicant Companies have, however, found that, during the normal running of such a tyre with a tread comprising a filler material positioned in an internal cavity, the filler material can degrade very quickly, long before it is exposed to the wear due to direct contact with a running surface.

### BRIEF DESCRIPTION OF THE INVENTION

The subject-matter of the invention is a tyre with a tread comprising a degradable filler material placed in a cavity, characterized in that the filler material comprises a blend of a degradable cellulose-based thermoplastic and of an unsaturated thermoplastic elastomer.

The filler material comprising such a blend has the advantage of exhibiting a reinforced stability during the running of the new and partially worn tyre, due to the grip between the filler material and the adjacent wall of the tread.

Preferably, the thermoplastic being in proportion A and the unsaturated thermoplastic elastomer being in proportion B, the B/A ratio varies from 0.1 to 1, A and B being expressed by weight. Very preferably, the B/A ratio varies from 0.25 to 0.75.

Advantageously, the unsaturated thermoplastic elastomer is a thermoplastic styrene elastomer.

Advantageously, the degradable thermoplastic is based on cellulose acetate.

Preferably, the degradable thermoplastic is composed of a blend of cellulose acetate and glycerol acetate.

Advantageously, the unsaturated thermoplastic styrene elastomer is a copolymer comprising styrene blocks and diene blocks.

According to a preferred embodiment, the cavity in which the filler material is placed is positioned radially internally relative to a usable part of the tread.

In this embodiment, the cavity in which the filler material is placed is internal to the tread and only becomes exposed to wear beyond a given wear threshold. It is then found that the filler material according to one of the subject-matters of the invention gradually breaks up and is thus discharged from the cavity of the tread. This allows the tread pattern of the tyre and in particular the discharge channels of this tread pattern to be reinforced by the cavity. This allows the tyre to retain its performance, in particular in capability of discharging water, of grip and of behaviour on wet ground.

According to one embodiment, the cavity forms a circumferential furrow, which can, for example, be a straight furrow.

Advantageously, the cavity is only exposed when the degree of wear of the tread is greater than 50% and preferably between 80 and 95%. This is because it is only when the wear of the tread becomes very high, above 80%, that a significant decline in the performance of the tyre is observed.

Another subject-matter of the invention is a thermoplastic composition comprising a blend of a degradable cellulose-based thermoplastic and an unsaturated thermoplastic styrene elastomer.

Preferably, the composition is such that the degradable thermoplastic is based on cellulose acetate and the unsaturated thermoplastic styrene elastomer is epoxidized.

The invention relates in particular to tyres intended to equip motor vehicles of passenger vehicle type, SUV (“Sport Utility Vehicle”) vehicles, two-wheel vehicles (in particular motorcycles), aircraft, industrial vehicles such as chosen from vans, heavy-duty vehicles—that is to say, underground, bus, heavy road transport vehicles (lorries, tractors, trailers), off-road vehicles such as agricultural vehicles or earth moving equipment—, or other transportation or handling vehicles.

### DETAILED DESCRIPTION OF THE INVENTION

In the present description, unless expressly indicated otherwise, all the percentages (%) indicated are % by weight.

Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

### Degradable Filler Material

The tyre according to the invention has the characteristic of comprising a tread with a degradable filler material placed in a cavity, and is such that the filler material comprises a blend of a degradable cellulose-based thermoplastic and of an unsaturated thermoplastic elastomer.

The filler material comprising such a blend has the advantage of exhibiting a reinforced stability during the running of the new and partially worn tyre, in particular as a result of the adhesion between the filler material and the adjacent wall of the tread of the tyre.

Preferably, the thermoplastic being in proportion A and the thermoplastic styrene elastomer being in proportion B, the B/A ratio varies from 0.1 to 1, A and B being expressed by weight. Very preferably, the B/A ratio varies from 0.25 to 0.75.

### Degradable Cellulose-Based Thermoplastic

The term “degradable cellulose-based thermoplastic” is understood to mean any formulation based on cellulose esters: for example, cellulose acetates, cellulose butyrates, cellulose acetates butyrates, cellulose propionates or cellulose acetates propionates.

The degradable cellulose-based thermoplastic is advantageously based on cellulose acetate.

It can be composed of a blend of cellulose acetate and glycerol acetate.

An example of such a material is “Biograde C9550”, sold by FKUR.

### Unsaturated Thermoplastic Elastomer

In a known way, thermoplastic elastomers (abbreviated to “TPE”) are provided in the form of block copolymers. They are intermediate in structure between thermoplastic polymers and elastomers and are composed of rigid thermoplastic sequences connected by flexible elastomer sequences, for example polybutadiene, polyisoprene or poly(ethylene/butylene).

This is the reason why, in a known way, TPE copolymers are generally characterized by the presence of two glass transition peaks, the first peak (lower temperature, negative) relating to the elastomer sequence of the TPE copolymer and the second peak (higher temperature, positive, typically in the vicinity of 80° C. or more) relating to the thermoplastic part (styrene blocks or others) of the TPE copolymer.

TPEs, like all thermoplastics, can be employed in an extrusion device when they are brought to a temperature greater than their melting or softening point. The melting point of a semicrystalline thermoplastic is determined by differential scanning calorimetry (DSC) according to Standard ISO 11357.

It should be remembered that the softening point is the temperature at which the material, for example in the powder form, sticks together. The softening point of a thermoplastic is measured according to Standard ISO 4625 (ring and ball method).

Preferably, the thermoplastic elastomers are thermoplastic styrene elastomers (abbreviated to “TPS”). The rigid sequences of the TPSs are thus based on styrene polymers.

The term “styrene” should be understood as meaning, in the present description, any monomer, unsubstituted or substituted, based on styrene; mention may be made, among substituted styrenes, for example, of methylstyrenes (for example, α-methylstyrene, β-methylstyrene, p-methylstyrene or tert-butylstyrene) or chlorostyrenes (for example, monochlorostyrene or dichlorostyrene).

These TPS elastomers are often triblock elastomers with two rigid segments connected by a flexible segment. The rigid and flexible segments can be positioned linearly, in star fashion or in branched fashion. These TPS elastomers can also be diblock elastomers with just one rigid segment connected to a flexible segment. Typically, each of these segments or blocks comprises a minimum of more than 5 and generally more than 10 base units (for example, styrene units and isoprene units for a styrene/isoprene/styrene block copolymer).

Having restated this, a first essential characteristic of the TPS elastomer used to manufacture the filler material is that it is unsaturated. The term “unsaturated TPS elastomer” is understood to mean, by definition and in a well known way, a TPS elastomer which is provided with ethylenic unsaturations, that is to say which comprises carbon-carbon double bonds (conjugated or nonconjugated); conversely, a “saturated” TPS elastomer is, of course, a TPS elastomer which is devoid of such double bonds.

Preferably, the unsaturated elastomer is a copolymer comprising styrene blocks (that is to say, polystyrene) and diene blocks (that is to say, polydiene), in particular isoprene blocks (polyisoprene) or butadiene blocks (polybutadiene); such an elastomer is chosen in particular from the group consisting of styrene/butadiene (SB), styrene/isoprene (SI), styrene/butadiene/butylene (SBB), styrene/butadiene/isoprene (SBI), styrene/butadiene/styrene (SBS), styrene/butadiene/butylene/styrene (SBBS), styrene/isoprene/styrene (SIS) and styrene/butadiene/isoprene/styrene (SBIS) block copolymers and the blends of these copolymers. The unsaturated thermoplastic elastomer can also advantageously carry functional groups chosen from epoxide, carboxyl, acid anhydride and acid ester groups.

More preferably, this unsaturated elastomer is a copolymer of the triblock type chosen from the group consisting of styrene/butadiene/styrene (SBS), styrene/butadiene/butylene/styrene (SBBS), styrene/isoprene/styrene (SIS) and styrene/butadiene/isoprene/styrene (SBIS) block copolymers and the blends of these copolymers.

Unsaturated TPS elastomers comprising styrene blocks and diene blocks have, for example, been described in Patent Applications WO 2008/080557, WO 2008/145276 and WO 2008/145277, which relate to airtight or self-sealing compositions intended in particular for tyres.

According to another preferred embodiment of the invention, the styrene content of the unsaturated TPS elastomer is between 5 and 50%. Outside the range indicated, there is a risk of seeing the targeted technical effect, namely an adhesion compromise, which is no more optimal with regard to, on the one hand, the filler material and, on the other hand, the diene rubber material which forms the walls of the cavity and is thus adjacent to the filler material. For these reasons, the styrene content is more preferably between 10 and 40%.

The number-average molecular weight (denoted Mn) of the TPS elastomer is preferably between 5 000 and 500 000 g/mol and more preferably between 7 000 and 450 000 g/mol. The number-average molecular weight (Mn) of the TPS elastomers is determined in a known way by steric exclusion chromatography (SEC). The sample is dissolved beforehand in tetrahydrofuran at a concentration of approximately 1 g/l and the solution is then filtered through a filter with a porosity of 0.45 μm before injection. The equipment used is a “Waters Alliance” chromatographic line. The elution solvent is tetrahydrofuran, the flow rate is 0.7 ml/min, the temperature of the system is 35° C. and the analytical time is 90 min. A set of four Waters columns in series, with the “Styragel” tradenames (“HMW7”, “HMW6E” and two “HT6E”), is used. The injected volume of the solution of the polymer sample is 100 μl. The detector is a “Waters 2410” differential refractometer and its associated software for making use of the chromatographic data is the “Waters Millennium” system. The calculated average molar masses are relative to a calibration curve produced with polystyrene standards.

Unsaturated and epoxidized TPS elastomers, such as, for example, SBS, are known and are available commercially, for example from Daicel under the name “Epofriend”.

The Tg of the above thermoplastic polymers is measured in a known way by DSC (Differential Scanning Calorimetry), for example and unless specifically indicated otherwise in the present patent application, according to Standard ASTM D3418 of 1999.

### Various Additives

The formulations based on cellulose esters can comprise plasticizers of different natures: mention may be made, nonexhaustively, of triethyl citrate, triethyl acetylcitrate, diethyl citrate, diethyl phthalate, triacetin, ethyl lactate, methyl lactate or castor oil.

These formulations can also comprise fillers of different types: calcium carbonate, titanium dioxide, silica, chalk, and the like, but also other types of additives of the following types: flame retardants, UV absorbents, stabilizers, and the like.

### Use Of The Degradable Filler Material In A Tyre

The filler material described above can be used to be positioned in any tread cavity of tyres for a motor vehicle, such as a vehicle of two-wheel, passenger or industrial type.

### DESCRIPTION OF THE FIGURES

The appended figures illustrate a machine for producing a tread with incorporated filler material and also such treads:

FIGS. 1 and 2 are two views, respectively in perspective and in vertical cross section, of a nose of a machine for producing a tread with filler material;

FIGS. 3 and 4 are two views, respectively in perspective and from the front, of the blade of the machine of FIG. 1;

FIG. 5 is a sectional view of the tread obtained by passing under the blade of FIG. 3;

FIG. 6 is a view analogous to FIG. 1 showing the positioning of the blade of FIG. 3 on the machine;

FIGS. 7 and 8 are two views analogous to FIG. 5 showing the strings introduced into the furrows on two treads of different tyres;

FIG. 9 is a view analogous to FIG. 6 showing the devices for guiding the strings into the furrows on the machine;

FIG. 10 is a front view of the part of the machine illustrated in FIG. 9;

FIGS. 11 and 12 are views analogous to FIGS. 7 and 8 showing the cross section of the tread when the furrows are closed;

FIG. 13 is a view analogous to FIG. 9 showing the filling devices of the machine of FIG. 1;

FIG. 14 is a view in perspective of one of these devices; and

FIG. 15 is view in cross section of the tread of the tyre manufactured by means of the machine.

### EXAMPLES OF THE IMPLEMENTATION OF THE INVENTION

### Manufacture Of The Degradable Filler Material

The manufacture of the degradable filler material is advantageously carried out by means of an extrusion device, preferably with a twin-screw extruder. Such an extruder makes it possible to obtain both the melting of the thermoplastic constituents of the composition and their intimate kneading.

T_{M1} is considered to be the given melting or softening point of the unsaturated thermoplastic styrene elastomer and T_{M2} is considered to be the given melting or softening point of the thermoplastic.

The manufacturing process comprises the following stages:
introducing the thermoplastic elastomer and the cellulose-based thermoplastic into the feed or feeds of the twin-screw extruder;
melting and kneading the constituents by bringing the combined mixture to a kneading temperature (T_{M}) greater than the two given melting or softening points (T_{M1}, T_{M2}) during the transfer into the body of the twin-screw extruder; and
distributing the resulting composition at the outlet of the twin-screw extruder with a die having an appropriate section.

The body of the twin-screw extruder is brought to a temperature T_{M} greater than the two melting or softening points of the thermoplastic components of the composition. This makes it possible to ensure, during the transfer of the constituents into the body of the extruder, both the melting of the two thermoplastic constituents and the kneading thereof. The difference in temperature must be greater than 5° C. in order for the melting to be complete and is preferably greater than 10° C.

It is possible to install, at the outlet of the twin-screw extruder, a die having a cross section appropriate for the planned usage of the filler material. For example, a die of cylindrical cross section corresponding to the diameter of a string to be introduced into a straight circumferential cavity of a tread of a tyre.

At the outlet of the die, as is well known to those skilled in the art, the string can pass through a cooling jig, which makes possible better control of the geometry on being drawn by a tread drawer, for example. It can subsequently be stored, for example in the form of a spool.

It is also possible, at the outlet of the die, to cool the outlet string by, by way of example, extrusion into a liquid and then to cut up the string into granules. The granules can be stored before being taken up in a second extrusion device in order to be finally formed before being incorporated in a tyre.

The unsaturated thermoplastic styrene elastomer and the thermoplastic can be introduced at the same time into the body of the extruder by means of the same feed.

The other optional additives of the filler material can also be introduced at the same time or subsequently.

### Manufacture Of A Tread With Filler Material

According to a first embodiment known per se, a tread with filler material incorporated in one or more cavities is produced by co-extrusion. The strings of filler material and the tread in which they are embedded are thus extruded together.

According to a second embodiment:
a rubber tread is extruded;
at least one furrow is formed in the tread;
at least one string is provided from a spool; and
the string is inserted into the or each furrow.

The strings are produced as indicated above prior to the formation of the rubber tread and separately from the latter. It is then sufficient to position them in the furrow and to close the latter. The strings are thus buried in the rubber subsequent to the formation thereof. This process limits the amount of scrap from manufacturing failings due to the fact that it makes it possible to dispense with the stages of stabilization of the process at the startup of each manufacturing series.

Preferably, for each section of the tread, the section is extruded and the furrow is formed in the section simultaneously.

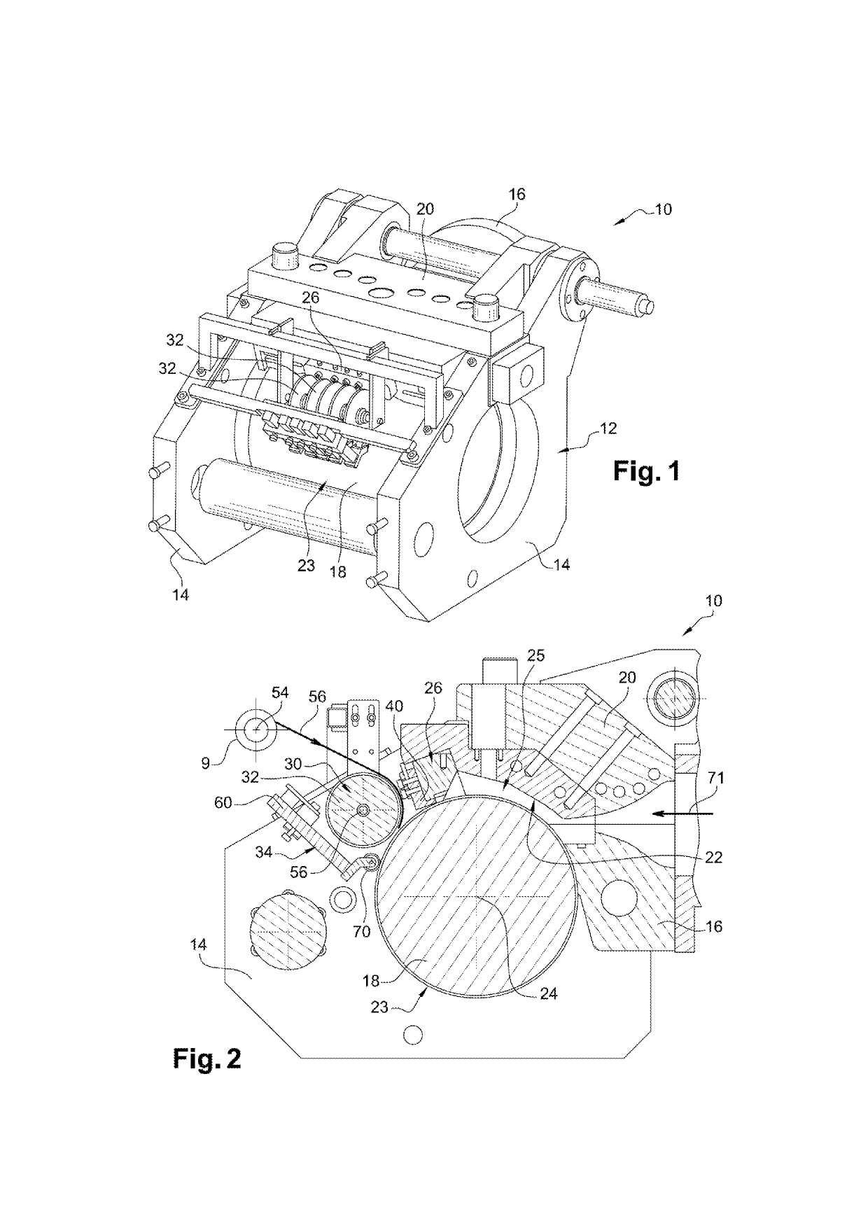

A description will now be given, with reference to FIGS. 1 to 14, of an embodiment of a machine which is, in the case in point, an extrusion machine used for producing a tread for the manufacture of a green vehicle tyre.

An illustration has been given, in FIG. 15, of a portion of a cross section of a tyre resulting from this manufacturing operation after vulcanization of the green tyre, the cross section being taken in a radial plane with reference to an axis 3 of the tyre. The tread 4 extends in the periphery of the tyre between the side walls of the latter and over its carcass 5, in the periphery of the latter. The tread 4 exhibits an external peripheral face 6 forming the surface via which the tyre will be in contact with the ground. This face has a cylindrical general shape of circular cross section.

The tread 4 comprises a main body formed of rubber, which conventionally comprises a blend of natural and synthetic elastomers and various products and adjuvants.

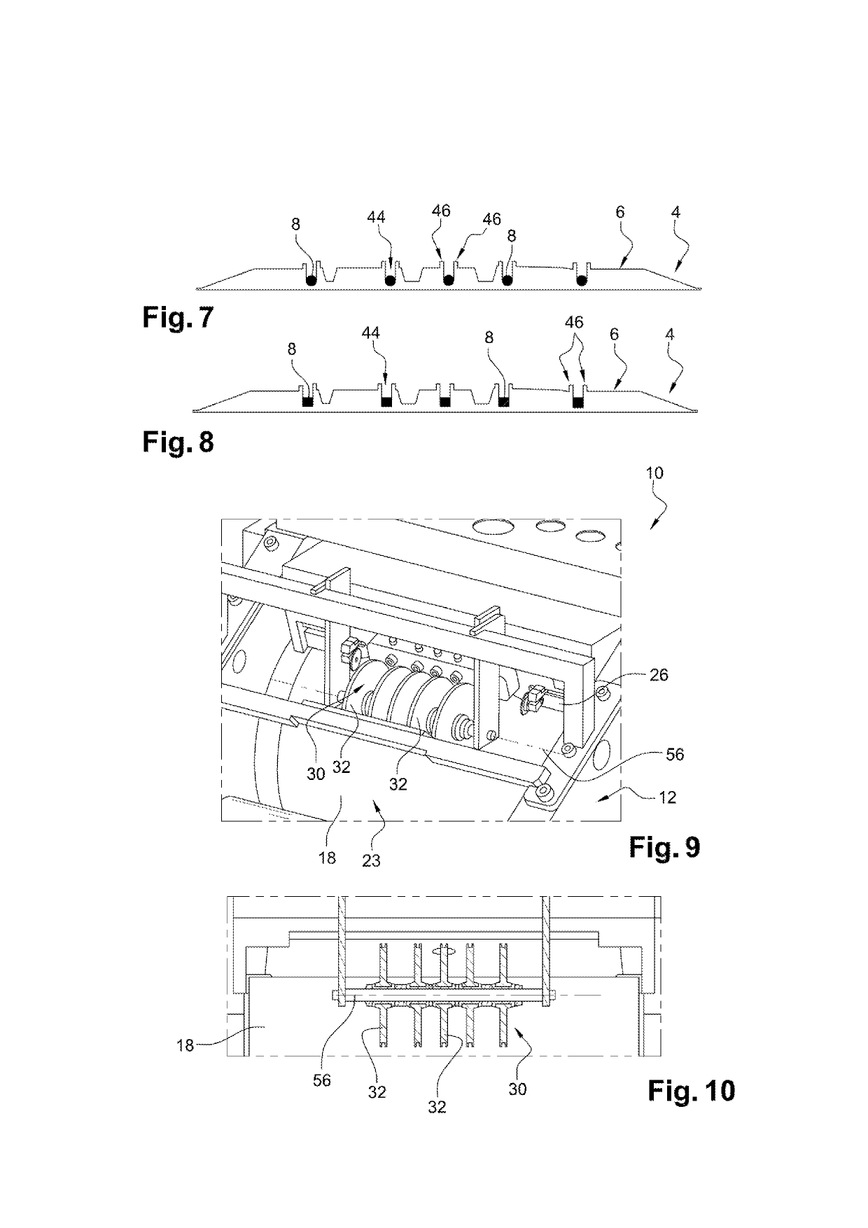

The tread 4 additionally comprises several strings or laces 8 which are, in the case in point, five in number this number not being limiting. The strings each have a wire form, with a circular cross section, as in the case in FIGS. 7, 11 and 15, or a square cross section, as in the case of FIGS. 8 and 12. The strings are embedded in the body and extend at a distance from the two main external and internal faces of the tread. Each string forms a circle coaxial with the tyre and extends in a plane perpendicular to the axis 3. The strings can have identical or different transverse profiles and can be composed of identical or different materials. The strings are produced individually, beforehand and separately from the body, and are then wound onto spools 9 (see FIG. 2) which are subsequently brought to the machine.

The nose 10 of the extrusion machine comprises a frame 12 comprising two vertical uprights 14 of planar form positioned in parallel to one another and facing and at a distance from one another. The majority of the devices of the nose extend in the space provided between the two uprights 14.

The nose comprises a conduit 16, illustrated in particular in the right-hand part of FIG. 2 and used to introduce the rubber intended to be extruded to form the body. The nose 10 comprises a cylinder or roll 18 positioned at the downstream mouth of the conduit 16 and exhibiting a cylindrical peripheral face 23 of circular section. The nose additionally comprises an assembly of parts 20 forming an arch 22 which delimits, with the face 23, a chamber 25 for pressurizing the material to be extruded, in which the conduit 16 emerges. The parts 20 are rigidly attached to the frame 12, whereas the roll 18 is fitted rotationally mobile, with respect to the uprights 14 around its horizontal axis 24, in the anticlockwise direction in FIG. 2. The nose 10 comprises a profiled blade 26 extending downstream from the chamber 25 and facing the face 23 of the roll. Downstream of the blade, the nose comprises an assembly 30 having fitting wheels 32 used to introduce the strings into the furrows produced beforehand, and also an stitching assembly 34 used to close the furrows over the strings thus positioned.

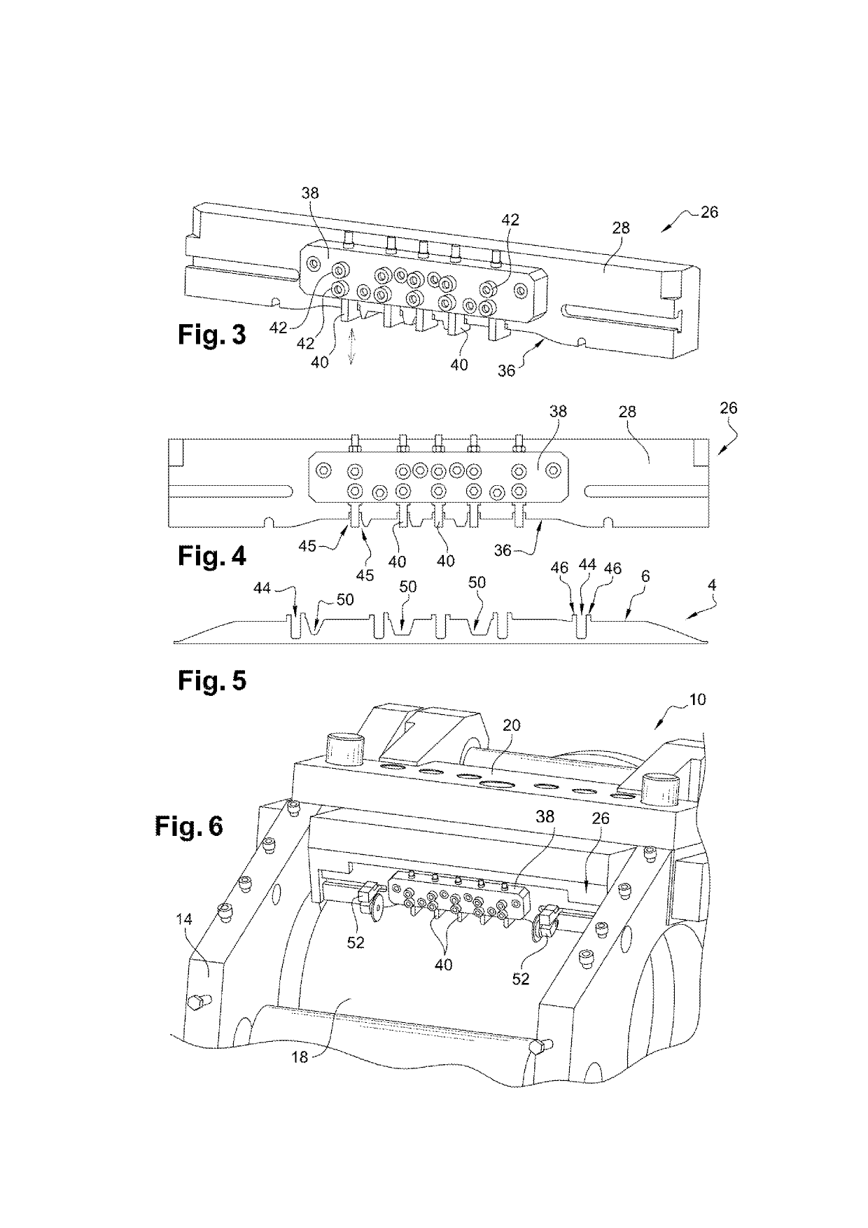

With reference to FIGS. 3 and 4, the profiled blade 26 comprises a main body 28 of elongated shape from one to the other of the uprights 14 and rigidly attached to these. The body 28 has a lower face 36 exhibiting cavities and protrusions and intended to give its form to the upper face 6 of the tread by the effect of passing the rubber between this face 36 and the face 23 of the roll. These two elements thus form an extrusion orifice which confers its form on the section of the tread 4 during the passage of the material.

The blade 26 additionally comprises a support 38 carrying ploughshares 40, the number of which equals that of the strings 8 which the tread is intended to receive, in the case in point five. As illustrated in particular in FIG. 2, each of the ploughshares 40 exhibits an “L” general shape, the longer part of the “L” extending in a direction close to the vertical direction and close to the direction radial to the axis 24, and being inserted into a dedicated orifice of the support 38 in which it is fitted so as to be able to move by sliding along this direction.

The blade 26 comprises, for each ploughshare 40, means for rigidly attaching to the body 28, which means are formed, in the case in point, for each ploughshare by two attachment screws 42 which pass through a part of the support and tighten the ploughshare against an internal face of the support. This arrangement makes it possible to adjust the position of the ploughshare with respect to the body 28 along the abovementioned direction and thus to adjust the depth of the furrow 44 produced by the corresponding ploughshare in the tread 4, for example depending on the model of tyre being manufactured.

The furrows 44 themselves are generated by the penetration of the base or small side of the “L” of each ploughshare 40 into the extruded material forming the rubber tread. The furrows are generated by the fact that the base of each ploughshare projects from the face 36 of the body 28 or more specifically from certain regions of this face, as illustrated in FIG. 4. The small side of the “L” is oriented so that the ploughshare penetrates under the profiled part of the extrusion blade. This particular setup makes it possible to position the upstream part of the ploughshare in a region where the pressure within the tread is not yet zero, which makes it possible to facilitate the penetration of the ploughshare into the material of the tread and the quality of the moulding.

The face 36 exhibits at right angles with each ploughshare a cavity 45 extending beyond the ploughshare on each side of the latter. Each of these cavities makes it possible to form, on either side of the furrow, respective protruding beads 46 forming surpluses of rubber projecting from the main part of the face 6. Each furrow thus extends between the two associated beads 46 which are contiguous with it.

As the number of furrows is equal to five in the case in point, ten beads are present. The furrows 44 are intended to receive the strings and then to be filled in, as will be seen later. The tread 36 is also configured in order to form furrows 50, in the case in point three in number, intended to visibly persist on the tread and on the final tyre, in contrast to the furrows 44. All the abovementioned furrows extend parallel to one another and in the longitudinal direction of the tread 4.

As illustrated in FIG. 6, the blade 26 additionally carries, in the case in point, two devices 52 forming knives for deburring the material in order to delimit the two opposite side edges of the tread. These devices are positioned facing one another, on either side of the support 38.

The extrusion machine comprises means 54 for receiving spools 9 on which the respective strings are wound. These means are arranged so as to allow the spools to unwind as the manufacturing operation proceeds.

The stitching assembly 30 (see FIGS. 6, 9 and 10) comprises wheels 32 which are equal in number, in the case in point, to that of the strings, namely five in number. The wheels are identical to one another and are mounted coaxially to one another around a horizontal axis 56. They extend facing the blade 26 so that a path 57 of the strings coming from the spools 9 passes between the assembly 30 and the blade 26 before they are inserted in the tread. During this path, the strings are supported against the circumferential peripheral edge of the respective wheels 32. Each wheel thus acts to guide the corresponding string as far as the bottom of the furrow in order to deposit it therein, the wheel for this purpose penetrating inside the corresponding furrow.

The wheels 32 are mounted on a common gantry attached to the frame, the vertical position of which is adjustable in order to cause the wheels to penetrate more or less deeply into the furrows and thus to insert the corresponding strings more or less into the latter. In the case in point, no motorized drive is provided for the wheels 32, the latter being driven in rotation by the forward progression of the tread and the strings inserted into this tread at the same peripheral speed as the latter. It is possible to provide an intermediate guiding part, such as a tube, traversed along its axis by the strings in order to guide them from the spools 9 as far as the assembly 30.

FIG. 7 illustrates the tread 4 with its open furrows 44, at the bottom of which have been deposited the strings 8 of filler material. This figure concerns strings having a circular cross section with a diameter of approximately 4 millimetres. FIG. 8 analogously illustrates the case of a tread 4, in the furrows 44 of which are positioned strings 8 of filler material exhibiting a cross section of parallelepipedal shape, for example square shape with a side length of 4 millimetres.

With reference to FIGS. 2 and 11 to 14, the stitching assembly 34 comprises stitching devices, the number of which is equal to that of the strings, namely five in the case in point.

One of these devices 60 has been illustrated in FIG. 14. The assembly 34 comprises a support 62 rigidly attached to the uprights 14 and extending from one to the other of these. Each of the devices 60 comprises a strut 64 of profiled form, received in a corresponding female orifice of the support 62 while being able to move by sliding in the latter along its longitudinal direction, which is similar to the direction radial to the axis 24. The assembly 34 comprises, for each device, a tightening element 66 which passes through the wall of the support 62 in order to tighten the strut 64 against an internal face of the support and thus to rigidly immobilize the device 60 with respect to the support 62 in the chosen position of adjustment.

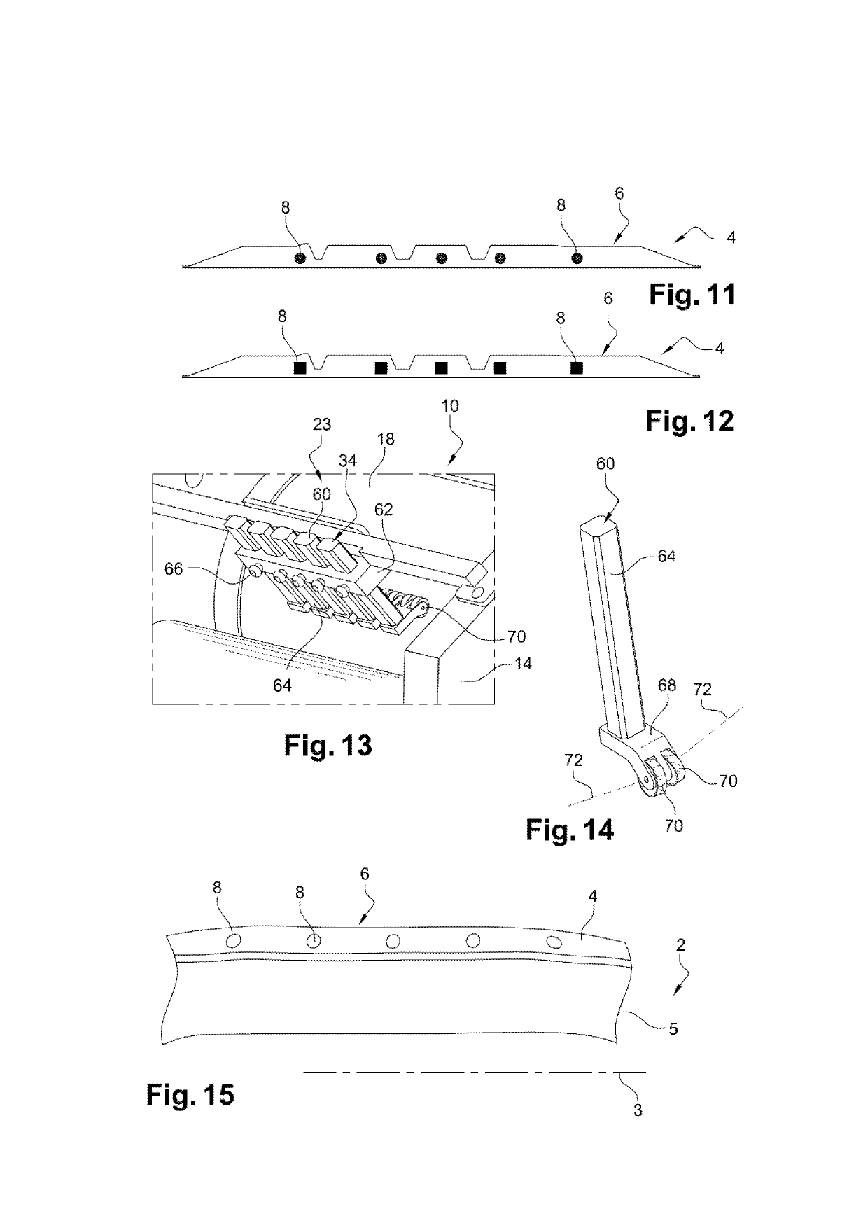

Each device 60 comprises, at a lower end of the strut, an arm 68 carrying two small toothed wheels 70 mounted in rotating fashion on the arm via respective axes of rotation 72 which are coplanar but intersecting and arranged so that the small wheels have an open configuration towards the upstream side with reference to the direction of forward progression of the tread. The small wheels are positioned so as to be supported against the respective beads 46 associated with the furrow under consideration, so as to turn down the material forming these protrusions into the furrow over the string 8 for the purpose of filling the furrow 44. The string is thus buried, covered and embedded in the tread, as illustrated in FIGS. 11 and 12 in the two cases corresponding to the respective FIGS. 7 and 8.

The process for the manufacture of the tread is carried out in the following way by means of this machine. The material forming the rubber is brought into the nose via the conduit 16 according to the arrow 71 and then passes into the chamber 25, where it is pressurized before being extruded through the extrusion orifice formed by the blade 26 and the roll 18. During this operation, which in particular gives the form to the upper face 6 of the tread, the ploughshares 40 produce longitudinal furrows 44 in the face 6 and also of two beads 46 situated on either side of each furrow. The ploughshares are present in a rear part in a region of the machine where the pressure is reduced with respect to the pressure prevailing in the chamber 25.

The spools 9 carrying the strings unwind and the strings, guided and supported by the small wheels 32, pass between these and the blade 26 in order to be inserted at the bottom of the respective furrows 44 in the thickness of the tread. The strings unwind from the spools under the effect of the tread being driven along, which also drives the wheels 32. The spool is not slowed down by any actuator during its movement.

The material forming the tread is still hot and soft at this stage. When the tread passes under the stitching assembly 34, the wheels 70 turn down the material of the beads 46 into the corresponding furrow, thus embedding the associated string in the thickness of the tread. The furrow is thus blocked and filled.

These operations take place successively for each section of tread under consideration. They take place at the same time for the whole of the tread, the treads being manufactured continuously.

### Tests

The properties of adhesion of the filler materials and adjacent rubber compositions are characterized as indicated below.

A Filler Material/Diene Layer Adhesion Tests

Adhesion tests (peel tests) were carried out in order to test the ability of the filler material to adhere after curing to a diene elastomer layer, more specifically to a normal rubber composition for a tyre tread, based on SBR rubber and silica (“Zeosil 165” from Rhodia), additionally comprising the usual additives (sulphur, accelerator, ZnO, stearic acid, antioxidant).

The peeling test specimens (of the 90° peeling type) were produced by stacking a thin layer of the test material, a 2-mm layer having the usual composition for a raw tread and, finally, a raw reinforcing ply which makes it possible to limit the deformation of the preceding layer during peeling. An incipient crack is inserted between the layer of test material and the layer of the tread type.

The test specimen, after assembly, was vulcanized at 180° C. under pressure for 15 minutes. Treads with a width of 30 mm were cut out using a cutting machine. These treads are then adhesively bonded on the side of the test material onto a metal support suitable for the setup and the other part is inserted into the tensile testing jaws. The tests are carried out at ambient temperature and at a pull rate of 100 mm/min. The tensile stresses are recorded and the latter are standardized by the width of the test specimen. A curve of strength per unit of width (in N/mm) as a function of the movable crossrail displacement of the tensile testing device (between 0 and 200 mm) is obtained. The adhesion value selected corresponds to the maximum value of this curve.

### Tests

TABLE 1

| | | Composition N°. | | | |
|---|---|---|---|---|---|
| | | (% by weight of the total) | | | |
| | | C-1 | C-2 | C-3 | C-4 |
| A | Cellulose acetate, Biograde C9550*² | 100 | 90 | 80 | 70 |
| B | Epoxidized SBS (eSBS) Epofriend | 0 | 10 | 20 | 30 |
| | AT501*¹ | | | | |
| B/A | | 0 | 0.11 | 0.25 | 0.42 |

*¹sold by Daicel;
*²sold by FKUR Kunststoff GmbH.

TABLE 2

| Composition No. | C-1 | C-2 | C-3 | C-4 |
|---|---|---|---|---|
| Peel stress maximum (N/mm) | 0 | 1.2 | 3.8 | 15.1 |

These tests show the advantage in the presence of the epoxidized thermoplastic styrene elastomer in strengthening the adhesion between the filler material and the adjacent wall of the material of the tread. This adhesion is substantial from a B/A ratio of 0.1. Preferably, this ratio is greater than or equal to 0.25.

However, it has been found that the rate of degradation of the filler material substantially decreases when the B/A ratio exceeds 1, i.e. when the composition of the filler material predominantly comprises an unsaturated thermoplastic elastomer. The preferred composition range is thus for B/A ratios between 0.25 and 0.75.

Tyres were produced comprising, in cavities of their treads, cylindrical strings of filler material corresponding to the composition C-4. The cavities were formed in the tread and the cylindrical strings were introduced into these raw cavities according to the process described above. The strings were positioned so as to begin to appear halfway through the life of the tyre after approximately 4 mm of wear.

These tyres are run normally until these inserts appear. From the time when they come into contact with the open air and on contact with the running pavement, the strings of filler material rapidly degraded, in a few hundred kilometres only, releasing the volume for the cavities and thus restoring the performance of the tyre, in particular the wet performance.

1-20. (canceled)

21. A tyre comprising a tread that includes a degradable filler material placed in a cavity of the tread, wherein the filler material includes a blend of a degradable cellulose-based thermoplastic and an unsaturated thermoplastic elastomer.

22. The tyre according to claim 21, wherein the thermoplastic is present in a weight proportion A, the unsaturated thermoplastic elastomer is present in a weight proportion B, and a B/A ratio varies from 0.1 to 1.

23. The tyre according to claim 22, wherein the B/A ratio varies from 0.25 to 0.75.

24. The tyre according to claim 21, wherein the degradable thermoplastic is based on at least one cellulose ester chosen from a group that includes: acetates, butyrates, acetates butyrates, propionates, and acetates propionates.

25. The tyre according to claim 24, wherein the degradable thermoplastic is based on cellulose acetate.

26. The tyre according to claim 25, wherein the degradable thermoplastic includes a blend of cellulose acetate and glycerol acetate.

27. The tyre according to claim 21, wherein the unsaturated thermoplastic elastomer is an unsaturated thermoplastic styrene elastomer.

28. The tyre according to claim 27, wherein the unsaturated thermoplastic styrene elastomer is a copolymer that includes styrene blocks and diene blocks.

29. The tyre according to claim 28, wherein the unsaturated thermoplastic styrene elastomer is chosen from a group of block copolymers that includes: styrene/butadiene (SB), styrene/isoprene (SI), styrene/ isoprene/styrene (SIS), styrene/butadiene/butylene (SBB), styrene/butadiene/isoprene (SBI), styrene/butadiene/styrene (SBS), and styrene/butadiene/butylene/styrene (SBBS), styrene/butadiene/isoprene/styrene (SBS); and blends of the block copolymers.

30. The tyre according to claim 29, wherein the unsaturated thermoplastic styrene elastomer is an SBS block copolymer or an SIS block copolymer.

31. The tyre according to claim 27, wherein the unsaturated thermoplastic styrene elastomer carries functional groups chosen from: epoxide, carboxyl, acid anhydride and acid ester.

32. The tyre according to claim 31, wherein the unsaturated thermoplastic styrene elastomer is an epoxidized elastomer.

33. The tyre according to claim 27, wherein the unsaturated thermoplastic styrene elastomer includes between 5 and 50% by weight of styrene.

34. The tyre according to claim 21, wherein the cavity of the tread is positioned radially internally relative to a usable part of the tread.

35. The tyre according to claim 34, wherein the cavity of the tread forms a circumferential furrow.

36. The tyre according to claim 35, wherein the circumferential furrow is a straight furrow.

37. The tyre according to claim 34, wherein the cavity of the tread is exposed when a degree of wear of the tread is greater than 50%.

38. The tyre according to claim 37, wherein the cavity of the tread is exposed when the degree of wear of the tread is between 80 and 95%.

39. A thermoplastic composition comprising:
a blend of a degradable cellulose-based thermoplastic; and
an unsaturated thermoplastic styrene elastomer,
wherein the degradable thermoplastic is based on cellulose acetate, and
wherein the unsaturated thermoplastic styrene elastomer is epoxidized.

40. A method of manufacturing a tread of a tyre, the method comprising:
placing a filler material in a cavity of the tread, in which the filler material includes a thermoplastic composition formed of at least:
a blend of a degradable cellulose-based thermoplastic; and
an unsaturated thermoplastic styrene elastomer,
wherein the degradable thermoplastic is based on cellulose acetate, and
wherein the unsaturated thermoplastic styrene elastomer is epoxidized.
